(19) United States
(12) Patent Application Publication
(10) Pub. No.: US 2008/0148261 A1
(43) Pub. Date: Jun. 19, 2008

(54) BATCH HANDLING FOR BACKGROUND FILE PROCESSING

(76) Inventor: ANDREW RODNEY FERLITSCH, Camas, WA (US)

Correspondence Address: MICHAEL BLAINE BROOKS, PC, P.O. BOX 1630, SIMI VALLEY, CA, 93062-1630, US

(21) Appl. No.: 11/612,047

(22) Filed: Dec. 18, 2006

(51) Int. Cl. G06F 9/46

(52) U.S. Cl. 718/101

(57) ABSTRACT

The embodiments of the present invention provide for proxy batch processing by invoking proxy applications and a single instance of an action application that is adapted to perform a wait function. In some embodiments, in addition to proxy applications, an intermediate application is invoked. The intermediate application is typically adapted to invoke, after a wait time expires, a single instance of an action application. In some embodiments, the intermediate application is adapted to invoke multiple instances of an action application, typically when such action application is not adapted to receive multiple object inputs or is not adapted to combine multiple objects into one batch output.

### FIELD OF THE INVENTION

The embodiments of the present invention relate to background batch processing, particularly when multiple files are selected.

### BACKGROUND

Batch processing improves user experience by facilitating similar actions to be performed, for example, on multiple files selected by a user. A way to process multiple files selected by a user as one batch job is highly desirable.

### SUMMARY

In one aspect, a method of proxy batch processing is provided. The method includes the steps of receiving a batch of one or more objects, wherein said batch is associated with an action application adapted to support said batch of one or more objects; invoking a separate instance of a proxy application for each object within said batch, wherein said each separate instance of the proxy application is associated with an object in said batch; determining by said each separate instance of said proxy application whether said action application is running; if said action application is not running, invoking an instance of said action application and passing the associated object of said instance of said proxy application to said action application; and if said action application is running, passing the associated object of said instance of said proxy application to said action application; wherein said action application is adapted to have a wait time and is adapted to terminate when said wait time expires without receiving any passed objects to said action application.

In another aspect, a computing device adapted to perform proxy batch processing is provided. The device includes a selection module, a context menu module, an action application, and a proxy batch module. The selection module is adapted to enable selection of one or more objects. The context menu module is adapted to present a context menu in response to an input, wherein said context menu is based on said selected one or more objects, and is also adapted to receive an action selection and associate said action selection to an action application. The action application is adapted to perform a wait function associated with a wait time, process said selected one or more objects based on said action selection, and terminate when said wait function expires without receiving any passed objects. The proxy batch module is adapted to invoke one or more instances of a proxy application, wherein each proxy application invoked is associated with an object from said selected one or more objects. Furthermore, each of said invoked proxy application is adapted to, if said action application is not running, invoke an instance of said action application and to pass the associated object of said instance of said proxy application to said action application; and, if said action application is running, pass the associated object of said instance of said proxy application to said action application.

In another aspect, a method of proxy batch processing is provided. The method includes the steps of receiving a batch of one or more objects, wherein said batch is associated with an action application adapted to support said batch of one or more objects; invoking a separate instance of a proxy application for each object within said batch, wherein said each separate instance of the proxy application is associated with an object in said batch; invoking an intermediate application; invoking by the intermediate application, after expiration of a wait time, the action application adapted to support said batch of one or more objects; and passing the batch of one or more objects as a set to said invoked action application.

In another aspect, a computing device adapted to perform proxy batch processing is provided. The device includes a selection module, a context menu module, an action application, a proxy batch module, and an intermediate application. The selection module is adapted to enable selection of one or more objects. The context menu module is adapted to present a context menu in response to an input, wherein said context menu is based on said selected one or more objects; and receive an action selection and associate said action selection to an action application. The action application is adapted to process said selected one or more objects based on said action selection. The proxy batch module is adapted to invoke one or more instances of a proxy application, wherein each proxy application invoked is associated with an object from said selected one or more objects; and wherein each of said invoked proxy application is adapted to pass the associated object of said instance of said proxy application to an intermediate application. The intermediate application is adapted to invoke said action application, after a wait time expires; and pass to said action application said one or more objects received from the proxy application.

In another aspect, a method of proxy batch processing is provided. The method includes the steps of receiving a batch of one or more objects, wherein said batch is associated with an action application adapted to support said batch of one or more objects; invoking a separate instance of a proxy application for each object within said batch, wherein said each separate instance of the proxy application is associated with an object in said batch; invoking an intermediate application adapted to perform a wait time function; invoking by the intermediate application, after expiration of a wait time, a separate instance of said action application for each object within said batch; passing the output of said each separate instance of said action application to said intermediate application; and combining each of the output of said each separate instance of said action application into one batch output, comprising data of each object of said batch.

In another aspect, a computing device adapted to perform proxy batch processing is provided. The device includes a selection module, a context menu module, an action application, a proxy batch module, and an intermediate application. The selection module is adapted to enable selection of one or more objects. The context menu module is adapted to present a context menu in response to an input, wherein said context menu is based on said selected one or more objects; and receive an action selection and associate said action selection to an application. The action application is adapted to process said selected one or more objects based on said action selection to produce an output; and transmit the output to the intermediate application. The proxy batch module is adapted to invoke one or more instances of a proxy application, wherein each proxy application invoked is associated with an object from said selected one or more objects; and wherein each of said invoked proxy application is adapted to pass the associated object of said instance of said proxy application to an intermediate application. The intermediate application is adapted to invoke one or more instances of said action application for each object within said batch, after a wait time expires, wherein each separate instance of the action application is associated with an object in said batch; receive the output of said each separate instance of said action application; and combine the received output of said each separate instance of said action application into one batch output, comprising data of each object of said batch.

### BRIEF DESCRIPTION OF THE DRAWINGS

The present invention is illustrated by way of example and not limitation in the figures of the accompanying drawings, and in which:

FIG. 1 is a high-level block diagram of an exemplary system according to an embodiment of the invention;

FIG. 2 is a block diagram of a prior art conventional batch processing method using a MICROSOFT WINDOWS™ drag and drop operation;

FIG. 3 is a block diagram of a prior art conventional batch processing method using a MICROSOFT WINDOWS™ context menu;

FIG. 4 is a block diagram of a prior art conventional batch processing method using a context menu and a running background application;

FIG. 5 is a high-level block diagram of graphical user interfaces (GUIs) depicting a file browser application and a context menu, according to embodiments of the invention;

FIG. 6 is a high-level block diagram showing an exemplary proxy batch process with an action application adapted to wait or linger, according to an embodiment of the invention;

FIG. 7 is a high-level flowchart illustrating an exemplary process of invoking an action application by an exemplary proxy application, according to an embodiment of the invention;

FIG. 8 is a high-level block diagram illustrating exemplary proxy applications in relation to an exemplary running action application, according to an embodiment of the invention;

FIG. 9A is a high-level block diagram showing an alternative embodiment of a proxy batch processing with a wait process relegated to an intermediate application, according to an embodiment of the invention;

FIG. 9B is a high-level block diagram showing another alternative embodiment of a proxy batch processing with a wait process relegated to an intermediate application, according to an embodiment of the invention;

FIG. 10 is a high-level flowchart illustrating an exemplary proxy batch process, according to an embodiment of the invention;

FIG. 11 is a high-level block diagram illustrating the timing of exemplary proxy applications, an exemplary intermediate application, and an action application, according to an embodiment of the invention;

FIG. 12 is a high-level block diagram representation of an exemplary batch print output using the exemplary proxy batch application, according to an embodiment of the invention;

FIG. 13 is a high-level block diagram of an exemplary computing device, according to an embodiment of the invention; and

FIG. 14 is a high-level block diagram of another exemplary computing device, according to an embodiment of the invention.

### DETAILED DESCRIPTION

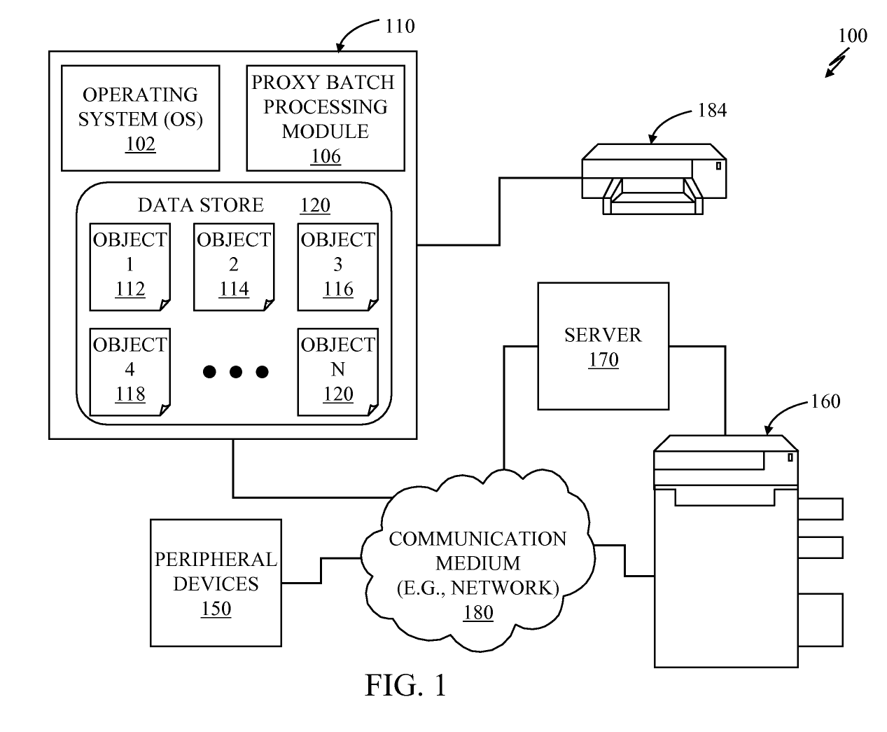

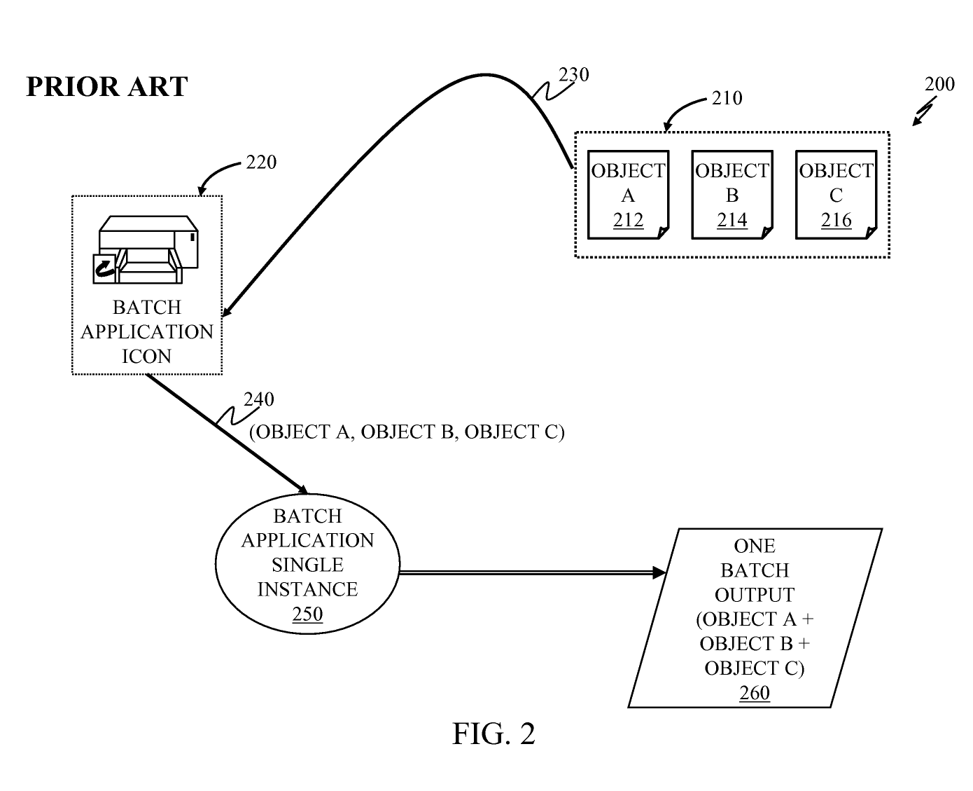

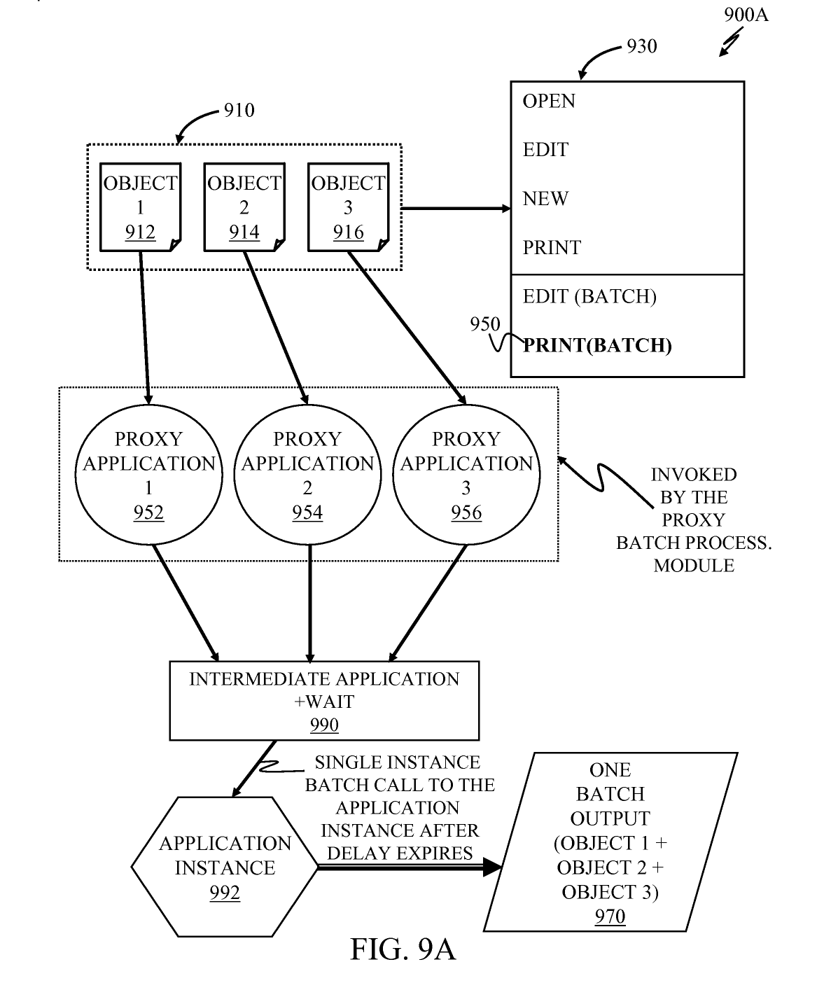

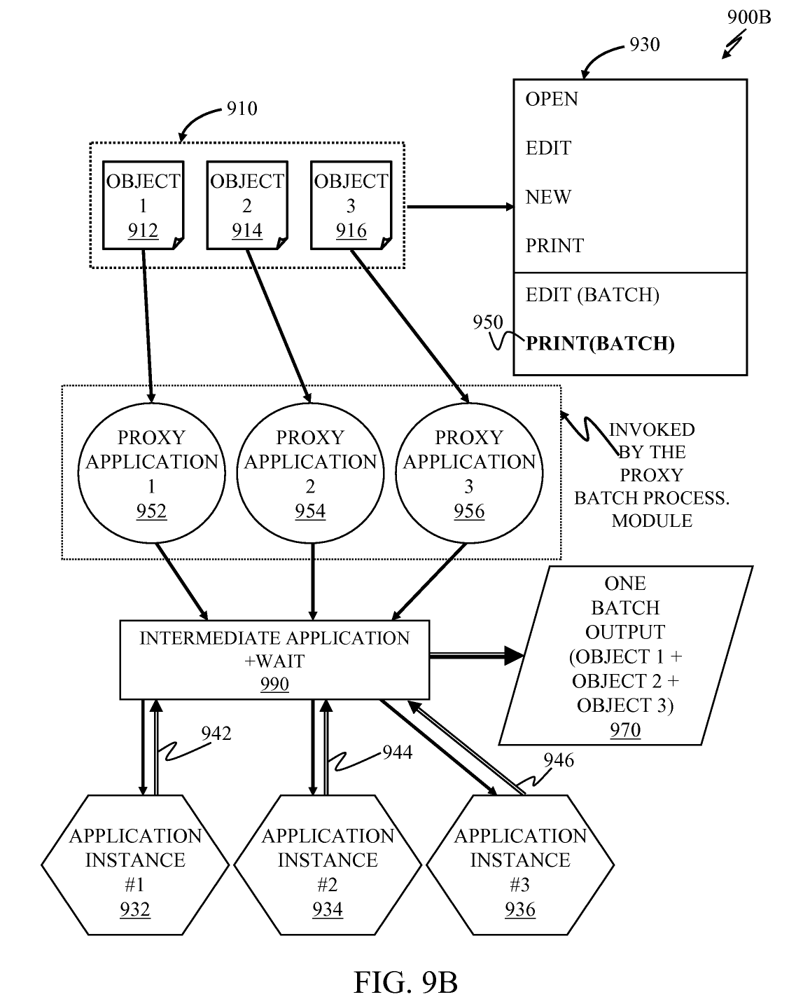

To better understand the figures, reference numerals within the one hundred series, for example, 112, 114, and 116, are initially introduced in FIG. 1, reference numerals in the two hundred series, for example, 212 and 216, are initially introduced in FIG. 2, and so on and so forth. So, reference numerals in the nine hundred series, e.g., 914 and 924, are initially introduced in FIG. 9.

The embodiments of the present invention relate to context menus, particularly to proxy batch processing initiated via context menus. The embodiments of the invention enable multiple objects to be selected as a group and processed as one batch by selecting the appropriate action option in a context menu. The selected objects are typically processed within one application instance, thus resulting in one batch output, rather than a series of outputs. In some embodiments, multiple application instances may be invoked and processed by an intermediate application resulting in one batch output, according to embodiments of the present invention.

FIG. 1 is an exemplary system 100 according to an embodiment of the invention. The system 100 typically includes a computing device 110, e.g., a general-purpose computer. In some embodiments, the computing device 110 is directly attached to a peripheral 184, such as a printer and/or facsimile machine, so as to enable a user to send, via the computing device, output to such peripherals for printing and/or faxing, for example. The computing device 110 typically includes an operating system (OS) 102 and a proxy batch (PB) processing module 106. The data store 120 is typically adapted to store objects 112, 114 116, 118, 120, such as, but not limited to, files, documents, pictures, music files, program instructions, e.g., software, and video sequences. The computing device 110 may also be part of a local area network 180, such that the computing device 110 is adapted to communicate with other devices or applications, for example, to print servers 170, fax servers 170, other computing devices, network peripherals 150, network printers 160, and other devices operably coupled to such network 180. This exemplary network 180 may include wired, wireless, or both wired or wireless network segments. The computing device 110 may also send proxy batch outputs to one or more operably connected devices, for example, via the network 180, such as to another peripheral 160 or to another computing device. The computing device 110 may also be operably coupled to a wide area network, not shown, such as the Internet, via the network 180 and an appropriate gateway and/or router device, such as known to those of ordinary skill in the art.

A computing device 110, if appropriately configured, may also be adapted to access objects from the local area network or from another network, e.g., the Internet, for processing. Examples of such processing may include faxing, printing, reading or opening, and editing. In some embodiments, objects from remote locations, e.g., via a network, may be selected for proxy batch processing, according to embodiments of the invention. Although the various embodiments of the invention are exemplified herein within the MICROSOFT (MS) WINDOWS® (WINDOWS) family of operating systems, the embodiments of the present invention may also apply to other operating systems, such as, but not limited to, APPLE MACINTOSH™ OS, Linux OS, System V Unix OS, BSD Unix OS, and OSF Unix OS.

Conventional batch processing, for example, in the MS WINDOWS environment is supported today. To distinguish the batch processing of the present invention against conventional batch processing, the batch processing embodiments of the present invention are typically referred to herein as “proxy batch (PB) processing” or as explained in the text of this disclosure.

A. Drag N' Drop Conventional Batch Processing:

FIG. 2 is a block-diagram of a conventional batch processing method 200 using the drag and drop feature available in the OS, e.g., within the MS WINDOWS OS. Using the drag and drop, a user may select multiple objects 210, for example, by clicking on each object 212, 214, 216, and by either holding down the shift key or the control key and dragging such selected objects to an appropriate batch processing application icon 220 for processing. For illustrative purposes, let us assume that the selected objects are ADOBE® portable document format (PDF) documents. The selected objects may then be dragged and dropped 230 onto or over a batch processing application icon 220, e.g., the application icon indicating a print action request for batch printing PDF files. The OS then invokes the batch processing application, associated with the icon 220, as a user process and with the selected objects 212, 214, 216, being passed to the batch processing application 250—in this example, Batch Printing for PDF—as an argument or parameter list 240 via the application's command line interface. In this exemplary conventional batch processing embodiment, the OS invokes a single batch application instance 250, e.g., one instance of Batch Printing for PDF, and the objects are passed 240, as an argument list into the single application instance 250 for conventional batch processing. The selected objects are printed together as one batch output 260, i.e., as one document—which includes, for example, object A data 212, object B data 214, and object C data 216. In this exemplary embodiment, no context menus are employed in this method. In this conventional batch processing method 200, only one instance of the batch action application or the batch application associated with the application icon 220 is invoked. The objects selected are typically all the same object type and/or are supported by the same action application, e.g., by the PDF Batch Printing/Processing application. In other embodiments, a batch processing application may support batch processing of different object types.

B. Conventional Batch Processing with Context Menus:

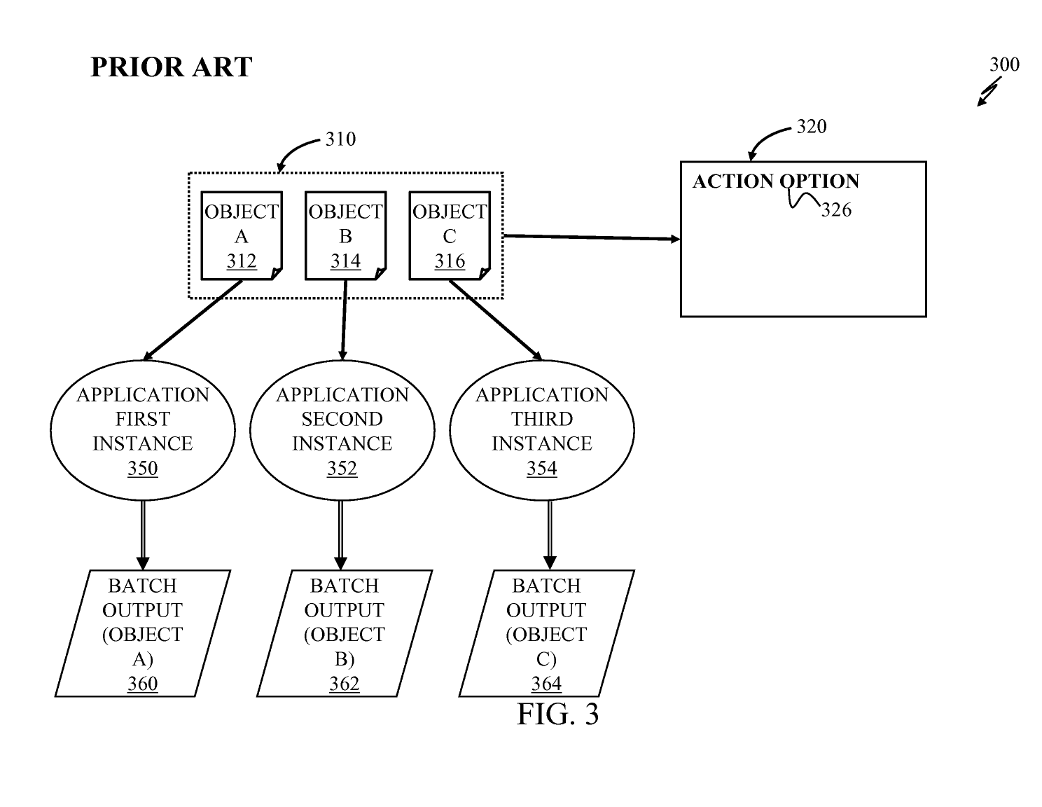

FIG. 3 is a block diagram of another prior art conventional batch processing method 300, which uses context menus. In this conventional batch processing method, a user selects one or more objects 312, 314, 316, for example, via a selection box region or by clicking the appropriate object(s). Typically, each object is identified with a file type, and each file type has one or more actions associated with that file type. After the selection of the object(s) 310, a user may invoke the context menu 320 by, for example, right clicking the mouse. Each action option 326 in the context menu 320 is typically associated with a shell command that typically invokes the action application, e.g., MS WORD, that supports the action requested. A user may then select an action option 326 to be performed on the selected object(s). For a single object selection, the OS executes the shell command typically invoking, as a background process, a single instance of the action application associated with the selected action option. By selecting multiple objects 312, 314, 316 and then selecting one option 326 of the appropriate action options, conventional batch processing 300 may be performed. When multiple objects 312, 314, 316 are selected, the OS does not issue a single shell command, but rather several shell commands—typically a separate shell command for each object selected, and with each separate shell command invoking a separate associated application. Thus, for each object 312, 314, 316, the OS invokes a separate application instance 350, 352, 354 respectively. The OS, thus, does not invoke a single application to process the multiple selected objects, but rather multiple instances of the action application. Thus, the selected objects 312, 314, 316 are not processed as a batch job with a single output, but several separate batch jobs with each job having a separate output as shown 360, 362, 364. The objects selected are typically all the same object type and/or are supported by the same action application, e.g., by the MS WORD application. In other embodiments, the objects may be of different object types and the OS may invoke instances of different action applications corresponding to the object type.

C. Conventional Batch Processing with Context Menus and Running Background Action Application:

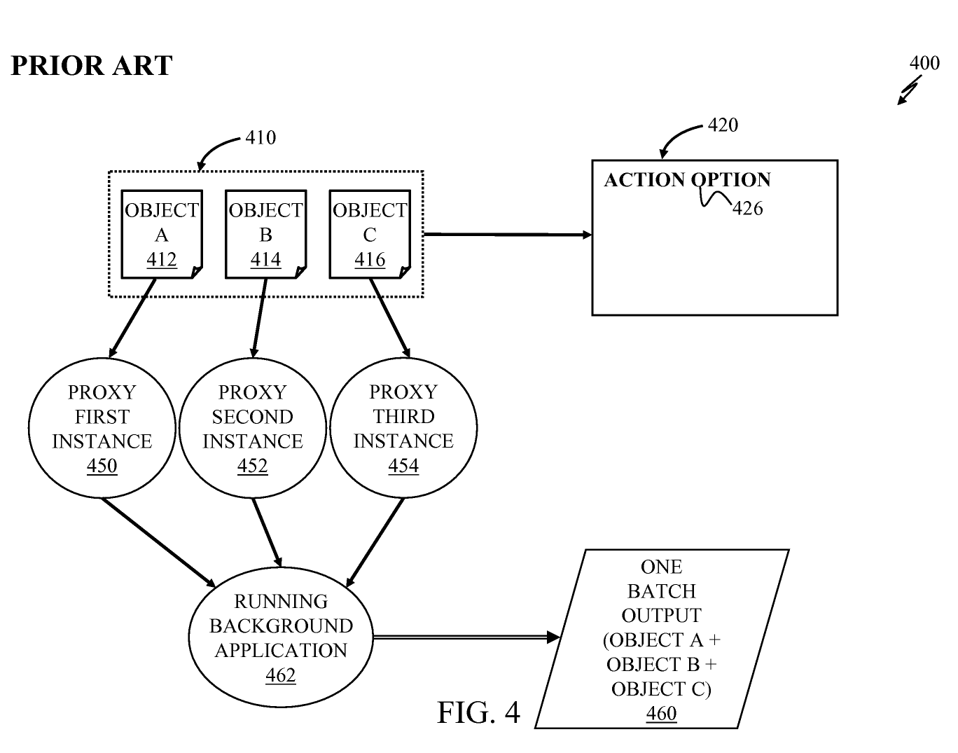

FIG. 4 is a block diagram of another prior art conventional batch processing method 400 using a context menu 420 and a running background application 462. After selection of the object(s) 412, 414, 416 for conventional batch processing 410, for example, via a selection box, a user may invoke the context menu 420 and then select the action 426 to be performed on the selected object(s) 412, 414, 416. In this conventional method 400, the action application 462, e.g., MS POWERPOINT, associated with the action option 426 is already running 462, for example, as a background process, such as a daemon process. When an action option 426 is selected from the pop-up context menu 420, the shell command associated with the action option, instead of invoking the associated application, invokes an instance of a proxy application 450, 452, 454 for each object selected 412, 414, 416. Each of the proxy applications 450, 452, 454 acts as a pass thru, i.e., each proxy application passes its associated object to the single instance of the running application 462. If the user, for example, selects three objects 412, 414, 416, three proxy applications 450, 452, 454 are invoked, i.e., one for each object. The running instance of the application 462 typically has been invoked prior to the creation of the proxy instances 450, 452, 454. A single batch output, containing data from object A 412, object B 414, and object C 416, is generated 460.

Because the application 462, however, is typically continuously running, in the background, the background application 462 may be unable to differentiate if an object passed by a proxy application is from the same group or batch of selected objects or from another group or batch. In some embodiments, it is possible that selected objects from different groups or batches are intermixed within the same output. The background application 462 is typically continuously running, considering that the application 462 is typically invoked, for example, at system boot up or start up, and normally terminates typically when the system shutdowns. In some embodiments, user intervention or error events may terminate the running application instance. The conventional batch processing method 400 is not designed to have the application instance 462 terminate after processing each batch job.

Proxy Batch Processing:

In the embodiments of the present invention, multiple objects, if selected as one batch job for proxy batch (PB) processing, results in one batch output per batch job. Assuming, for example, a user selects multiple MS WORD documents for print PB processing, the PB processing prints one output, typically incorporating all the selected MS WORD documents, rather than generating multiple outputs. The printer, if adapted to perform print-handling functions, such as stapling or binding, for example, may process the output as one single batch thereby enabling the printer to staple the single batch output as one document rather than separate multiple documents. If the PB processing is a fax action, the multiple selected documents may be faxed as one batch document or output rather than having each of the documents faxed as a separate document. Other PB processing actions, such as, but not limited to, copying, archiving, compressing, decompressing, and the like may also be applied in the embodiments of the present invention.

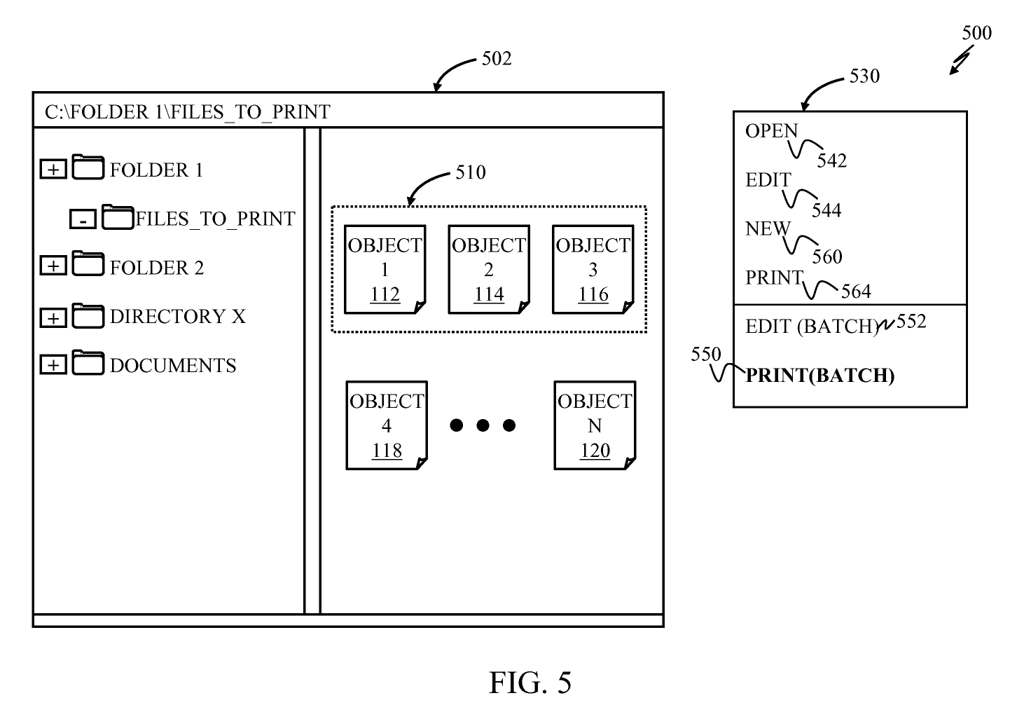

FIG. 5 is a high-level block diagram of exemplary graphical user interfaces (GUIs) 500, for example, within an MS WINDOWS™ environment, according to embodiments of the invention. In general, a user may select a number of objects for PB processing via context menus. Objects herein may include files with various file types and/or file formats, which may include word-processing files, image files, web browser files, mail files, archive files, audio files, video files, or any objects, including files, recognized by the OS. Such objects may include streaming data, for example, those streamed to a computing device, e.g., videos.

In some embodiments, an exemplary operating environment consists of a computing device 110 with a windowing operating system, such as the MS WINDOWS™ family of operating systems. Within this exemplary OS 102, a user is enabled to select multiple objects, which is typically a subset of available objects 112, 114, 116, 118, 120 within or accessible by the computing device 11 0. Such objects may be local or remote objects. In some embodiments, these objects are available for selection via a file explorer or browser application 502 available within the OS environment, e.g., the EXPLORE application within the MS WINDOWS™ OS. Selectable objects may be represented, for example, as icons or as file names on a desktop or within folders. An exemplary method of selecting objects may include placing a cursor on one object at a time and clicking a button on a mouse, while holding down the shift or control key; dragging a selection box across a region containing the objects; or selecting an operation request within a file folder or an application, e.g., “Select All”—for selecting objects within that folder. Other ways of selecting a group of objects are known to those of ordinary skill in the art.

Once the set of objects are selected 510, the user may initiate a context menu selection 530, for example, by depressing the right button on the mouse, i.e., via a right click. Typically, the OS 102 then displays the context menu 530 with a list of action options 542, 544, 560, 564, 552, 550. In some embodiments, context menus may be invoked with a secondary mouse button, e.g., the right button, on a computing device running an OS, such as MS WINDOWS, Mac OS X, or UNIX on an X Window System. Computing devices typically with a single-button mouse may also have access to context menus via a keyboard-click combination, e.g., control-click in the Macintosh OS. Keyboards with MS WINDOWS keys typically also have an additional menu key that initiates the context menus to pop-up in MS WINDOWS applications. In some embodiments, context menus may be hierarchically organized, enabling a user to navigate through different levels of the menu structure, for example, by selecting an action option with a right arrow. Various other embodiments of the context menu are available, which in some embodiments may depend on the OS.

The list of action options 542, 544, 560, 564, 552, 550 in a pop-up context menu 530 may vary depending on the context of the action, the running application(s), the object(s) selected, and/or file type. For example, in the MS WINDOWS® operating system, typically a file type-e.g., with a “.doc” extension, may be associated with one or more actions. Objects with the “.doc” extensions and “.pdf” extensions are objects, for example, supported by the MS WORD application and the ADOBE® Acrobat application, respectively. Files with “.html” extensions may be supported by various applications, which may include web browser applications, such as MS Internet Explorer and Mozilla FIREFOX™, and, in some embodiments, even by word-processing applications, such as MS WORD. These exemplary applications may support actions, e.g., open, print, send to, cut, copy, and delete. The actions supported by such exemplary applications may be presented as action options 542, 544, 560, 564, 552, 550 in the context menu 530. Examples of action options may include printing, file transfer, filing, faxing, archiving, emailing, publishing, and document composition.

In some embodiments, the context menu 530 includes not only conventional processing actions 542, 544, 560, 564, but also options 552, 550 associated with PB processing. This type of context menu enables a user to utilize conventional action processing 542, 544, 560, 564—for single object selection and conventional batch processing—for multiple object selection, as described above (see FIGS. 2, 3, and 4), as well as select PB processing actions 552, 550 of the present invention. In other embodiments, the OS and/or the appropriate action applications may be modified such that the conventional batch processing method using context menus (see FIG. 3), without the daemon process, as described above is replaced with the exemplary PB processing features described herein. For example, after selecting multiple objects and after selecting an action option on a context menu, the PB processing of the present invention is invoked rather than the conventional batch processing via context menu of FIG. 3. This way, when multiple objects are selected, a consistent way of batch processing in general is provided to the user, i.e., multiple objects selected in a batch are processed as a batch, and if there is an output, the output is one batch output rather than multiple separate outputs.

Context menus currently available in the various OS may be modified so that they may incorporate or be replaced with PB action options. For example, context menu handlers available in the MS WINDOWS OS may be used to insert action options on a particular context menu. Context menu handlers, in addition to being able to handle static action options, may also be used to dynamically add action options on context menus. Action options may also be made available on a context menu by hard-coding information in the registry, e.g., via the REGEDIT application in MS WINDOWS. Other means of providing additional action options and modifying or deleting action options in a context menu are known to those of ordinary skill in the art.

In this example, PB actions 552, 550 are identified by having the term “(BATCH)” added in the action option label, as shown. There are two proxy actions shown 552, 550, and the user may, for example, select the Print PB action 550, by clicking on such option. Other ways of indicating PB processing may be implemented, which may include colors, tooltip displays, help functions, label or text, and/or submenu options.

A batch is typically identified as a group of selected object(s) that is associated with the same instance of action option or action selection intended to be processed as one unit. In this example, objects 1, 2, 3 are considered as belonging to the same batch 510, considering these objects were already selected when the user selects the PB action option 550. The selection of the action 550 in the context menu thus identifies or delineates a batch. If the user makes another selection of objects (not shown), e.g., objects 4 and 5, and then invokes the context menu and then selects another PB action, objects 4 and 5 may then be deemed as another batch containing these two objects.

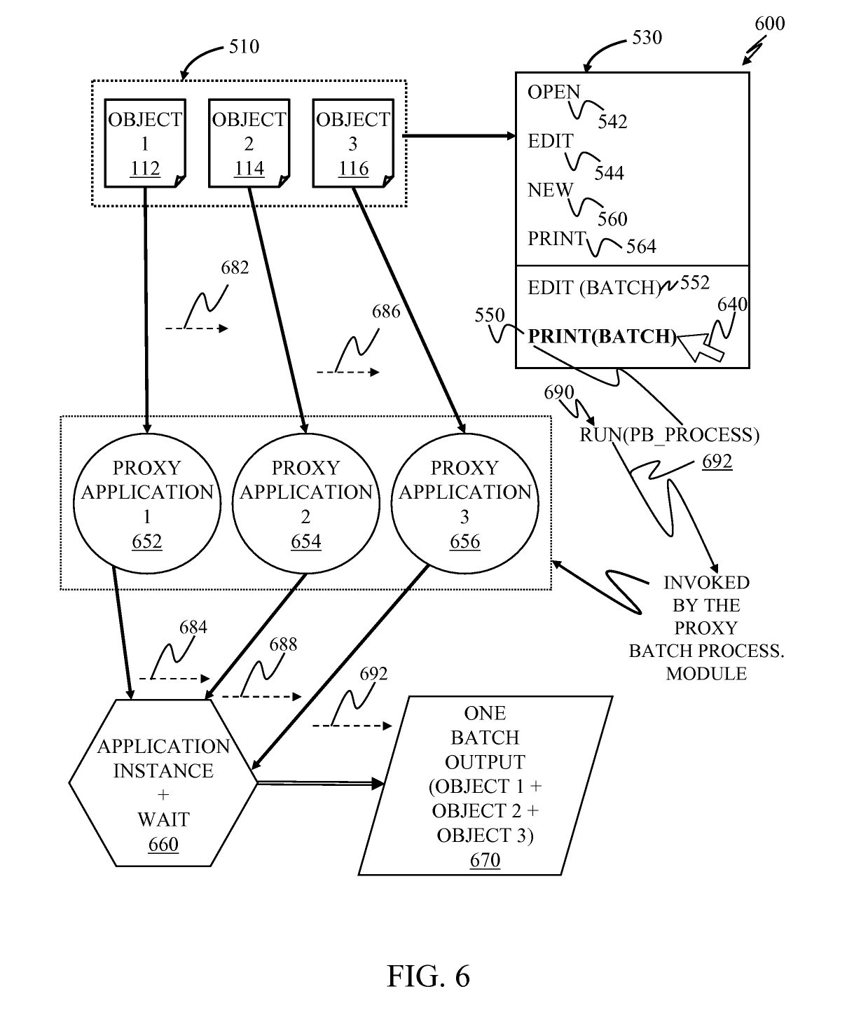

FIG. 6 is a high-level block diagram showing an exemplary PB batch processing 600, according to an embodiment of the invention. The embodiments of the present invention provide an exemplary PB processing that enables a user to select multiple files for PB batch processing, as well as enable a user to separate the processing of one batch to another. Continuing the discussion from FIG. 5, a user selects three objects—object 1, 2, and 3 112, 114, 116—for PB processing. The user invokes the context menu 530 and selects the appropriate PB action 550. The action options in the context menu typically indicate what action is to be performed on the batch of selected objects 112, 114, 116. The user may select the appropriate action by clicking the action option 550, typically via a mouse interface, e.g., a cursor 640. The exemplary PB action selected is the print PB action 550. The selected objects 112, 114, 116 are considered to belong to the same batch 510.

In some embodiments, each action 542, 544, 560, 564, 552, 550 is typically associated with a set of command instruction(s), e.g., embodied as a shell command. In this exemplary embodiment, the OS presents context menus that incorporate conventional action options 542, 544, 560, 564 and PB action options 552, 550. The exemplary action options shown, for example, may be shown if MS WORD objects are selected for processing. Other actions may also be presented. If a user selects a conventional action 542, 544, 560, 564, the OS typically executes the conventional command, e.g., shell command, associated with these actions accordingly. In some embodiments, conventional batch processing is performed, as discussed above, if multiple objects are selected.

When the user selects a PB action option 552, 550, e.g., print PB action 550, the OS 102 typically invokes, e.g., via a shell command—e.g., RUN(PB_PROCESS) 690, the PB processing module 106 embodied as another application. Other ways of invoking the PB processing features may also be implemented, for example, as a web service (WS). The PB processing module, embodied as an application, then typically invokes 692 a separate instance of a proxy application per object in the batch 510. In this example, three separate instances of a proxy application 652, 654, 656 are invoked, with each proxy application associated with a respective object, i.e., proxy application 1 652, proxy application 2 654, and proxy application 3 656 are associated with object 1 112, object 2 114, and object 3 116, respectively. The proxy application is also associated with or knows the appropriate action application to invoke. This information may have been passed to each instance of the proxy application 652, 654, 656 by the PB processing module 106, e.g., as an argument, not shown, included in the shell command 690.

In some embodiments, the selection of the action 550 directly invokes, e.g., via one or more shell commands (not shown), the various instances of the proxy application 652, 654, 656, e.g., one shell command for each proxy application. In this embodiment, the PB processing module 106 is embodied as a set of one or more shell commands. In these embodiments, the OS invokes the appropriate proxy applications.

A single instance of the action application associated with the objects 660, e.g., MS WORD, is also instantiated. Typically such instantiation is at the request of the first proxy application 652. Typically, the objects in each batch are supported by the same action application 660. If all the objects are of the same object type, then the action application may be adapted to support batch processing of the one object type, e.g., batch processing for PDF objects. Otherwise, the action application is adapted to support the object type of each object in the batch, i.e., adapted to support multiple object types, e.g., plain text object types and MS WORD object types. In other embodiments, the different object types may be associated with different action applications. In this exemplary embodiment, the output or outcome is captured by the proxy application and coalesced into a single output or outcome.

Furthermore, the application instance 660 waits or temporarily lingers after the processing of each object, but typically terminates based on certain conditions, e.g., when the wait or linger time has expired without receiving any more objects for processing. The selected objects 112, 114, 116 are processed by the associated action application 660 and a batch output 670, including data from the selected objects 1, 2, and 3 112, 114, 116, is typically generated or processed. In some embodiments, no external output, e.g., no printout, is generated by the PB processing module but the selected objects are PB processed according to the embodiments of the invention.

During the invocation of the single instance of the action application 660 or during the passing of information to the running action application 660, the proxy application may indicate or signal to the action application to enter into the PB processing mode. This may be handled by having the proxy application pass an argument, recognized by the action application 660, as indicating to enter and process in the PB mode. In other embodiments, a flag is set which is monitored by the action application. Various ways of indicating to an action application to enter into the PB mode are known to those of ordinary skill in the art. By entering into the PB mode, the action application is adapted to linger for a certain amount of time after or before processing each object, for example, or be adapted to conjoin or add any subsequent object processing request(s) with the previous object request, if such object processing request(s) are made, for example, within any wait time or at any time while the action application is still running. In some embodiments, the wait time is within the processing of the object.

The wait feature may be incorporated in a number of ways. In some embodiments, the proxy application 652, 654, 656, may define when the wait is to occur, for example, via wait or sleep commands or any available commands that inform the application to perform a wait/linger state. These commands may depend on the OS environment, the programming languages used to invoke the application, the software engineering technique employed, and/or the application programming interfaces (APIs) available in the OS or in the action application. In some embodiments, the proxy application initiates the application instance 660 and passes wait time information arguments. Furthermore, the action application may be modified so as to be adapted to perform a wait or linger process if the action application is invoked in the PB processing mode. For example, the wait or linger process may be implemented within the action application 660, for example, modifying the conventional MS WORD application, so as to be adapted to go into a wait state when the PB processing mode is invoked. The action application 660 thus in general is adapted to perform several PB functions, such as adapted to accept multiple objects or files as input, batch the multiple objects into a composite job for PB processing, and wait the appropriate linger/wait times. Another embodiment of a wait process according to another embodiment is disclosed further below in FIG. 9A.

The embodiments of the present invention are also adapted to distinguish one batch job from another, even if the batch jobs are all associated with the same action application. Considering that the single application instance 660 terminates based on certain conditions, a new batch job may be distinguished from one batch to another, even if the application instance applied in the first batch is the same application to be applied or employed in the second batch. For illustrative purposes, let us assume that the application instance is MS WORD, and the application instance 660 has processed all selected objects from the first batch job, i.e., objects 1, 2, and 3, and that the wait time has expired. The MS WORD application instance 660 then terminates. A user may then select a new batch for PB processing, for example, selecting objects 4 and 5, not shown. MS WORD is then instantiated again, and MS WORD accordingly processes objects 4 and 5 as a different batch.

In some embodiments, when the linger/wait time expires, the action application 660 then enters into a mode, wherein the action application is not adapted to accept new objects from any of the proxy application associated with the current batch, for example. In this exemplary embodiment, typically the first proxy application of the next batch then starts a new instance of the action application 660, i.e., for the second batch, which may temporarily run in parallel with the first batch.

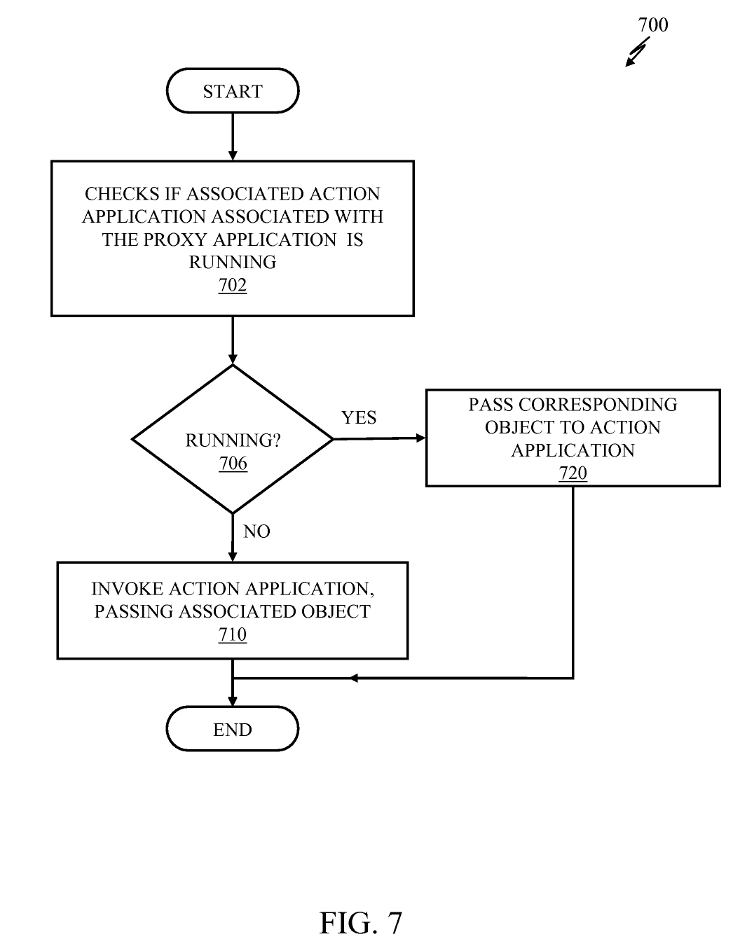

FIG. 7 is a high-level flowchart illustrating an exemplary process 700 of invoking an action application 660 by an exemplary proxy application 652, 654, 656, according to an embodiment of the invention. As discussed above, after the selection of the PB action 550, a first instance or a first proxy application 652 is invoked, e.g., by a shell command associated with the PB action option, by a PB module embodied as an application, or by a PB module embodied in multiple shell commands. This proxy application typically is associated with or is aware of the action application to be invoked. The information on which application is to be invoked may be based on the object information, e.g., file type or as defined within the computing environment. This information may also have been passed to the proxy application 652 as a parameter by the PB processing module 106. Typically, a proxy application 652 checks if the action application associated with the proxy application is running, i.e., if the action application 660 adapted to support the selected objects is running (step 702).

The process of determining whether the action application is running may be performed in a number of ways. For example, the proxy application may query the OS for currently running tasks, for example, via available classes or processes adapted to determine currently running tasks or applications, which may depend on the OS. For example, in the .NET framework of MS, a System.Diagnostics.Process class is available, enabling users and applications to obtain a list of currently running Win32 processes in the system. Other commands adapted to perform such process may also be used, as known to those of ordinary skill in the art. In other embodiments, the proxy application may inspect various tasks and processes, for example, to determine evidence that the action application is running, such as via an inter-process semaphore, an access lock on a special predetermined file, or the existence or non-existence of a predetermined file. Such evidence may depend on the action application. Semaphores may also be used to restrict access to shared resources. For example, when the action application 660 is invoked, the action application 660 may request the OS to set a named semaphore, which is global across all processes. When the action application terminates, the OS releases the named semaphore. The proxy application may then check for the presence of the action application 660 by requesting the OS to set the same named semaphore. If the action application is running, i.e., the semaphore is set, the proxy application's request to set the semaphore thus fails, thereby indicating that the action application is currently running.

In some embodiments, an action application 660 is designed such that certain files are locked or prevented from being accessed while such application is running. In other embodiments, certain applications create and maintain files during its execution. The proxy application of the present invention thus may be coded so as to be adapted to look for certain evidence(s) to determine if an action application is running or not.

If the associated action application 660 is not running (step 706, “no” branch), typically the first instance of the proxy application—e.g., proxy application 1 652, the proxy application invokes the associated action application 660 typically as a background process, e.g., a non-windowing process, and passes the object to the invoked action application (step 710). In some embodiments, the invocation of the action application is via a command line interface, e.g., Main( ) command invocation if the proxy application is coded using, for example, C# (C-Sharp). Other software engineering techniques may also be used to invoke the action application. If the associated application, however, is running (step 706, “yes” branch), the proxy application passes the appropriate object to the running action application for processing (step 720). This operation is typically performed by the second or later instances of proxy applications 654, 656. The proxy application may pass the object information to the instantiated action application in a number of ways—for example, as an argument to a command line invocation, by placement of the object information in a file in a predetermined folder or location, which is then monitored by the action application, and/or by triggering an event which the action application is registered to receive. The exemplary process 700 described herein is typically performed by each proxy application.

Referring back to FIG. 6, when the associated action application 660, is invoked typically by the first instance of a proxy application 652, the action application typically lingers or wait for some amount of time or period 684, for example, after completing the processing of the first object 112. In some embodiments, shell commands with an argument list, including wait time, may be used to invoke the action application. If the wait time expires, the application instance typically terminates. The wait or linger time may be predetermined, dynamically adjusted, or based on other conditions.

After the first instance of the proxy application, the next instance 654, e.g., proxy application 2, within the same group or batch, is typically invoked within a time 682 that is typically less than the linger or wait time 684, such that this next proxy application 654 is invoked while the action application 660 is still running to avoid another instantiation of the application instance 660 because the application instance 660 has already terminated. In some embodiments, the wait time 684, 688, 692 is sufficiently long enough to cover the time difference for the OS to sequentially invoke two instances 682, 686 of the proxy application, but typically not so long as to mistakenly include a new invocation of a new batch by the user.

The linger or wait time of the present invention, typically assumes a difference between computer processing time and human interaction time. The embodiments of the present invention assume or consider that the requests for proxy batch processing are manually initiated by a human user. When a user completes issuing a request for the first PB processing, a user typically uses a user interface device, e.g., repositions a cursor and operates a mouse, and/or keyboard, to request the second PB processing. Typically, a human being may perform this manual task or user interaction switch between two proxy batch requests, for example, in less than half a second. But a computing device, such as a general-purpose computer, which typically operates a time sharing central processing unit, is able to switch from one task to another, e.g., task switch between dispatching sequential object processing requests, in a miniscule fraction of a second. Thus, the linger/wait time is long enough so that that these computer-driven overlapping operations may be executed, but not so long as to mistake the sequential requests as human-driven overlapping operations.

In some embodiments, the wait time is approximately ½ second or less. The subsequent proxy application 654, because it is typically invoked while the action application 660 is still running, e.g., within the wait time 684, is able to detect the running application instance 660, and thus does not invoke another instance of the same action application but passes the object to the running application 660. The instance application 660, upon receipt of the additional object, e.g., object 2, to be processed 114 within the same batch, processes that object and accordingly also lingers or waits for a certain time 688, typically waiting for the next object to be received from another proxy application instance. The next proxy application 656, proxy application 3, is also then invoked while the application instance 660 is in the wait time 688, thus the proxy application 3 does not invoke a new instance of the action application, but passes the object to the instance application. This process is typically repeated in the same kind of manner for subsequent proxy applications within the same batch. A wait time is typically implemented for each object processed.

Once the instance application has processed the last object 116 in the batch, the application instance 660 accordingly also waits. Once the wait time 692 expires, typically without receiving any objects, the action application 660 terminates, thereby terminating the PB processing for that job in general, including ending or closing the action application instance. Another PB process may also be accordingly invoked. In some embodiments, the proxy application simply passes the object(s) to the action application and either terminates immediately or terminates upon termination of the action application.

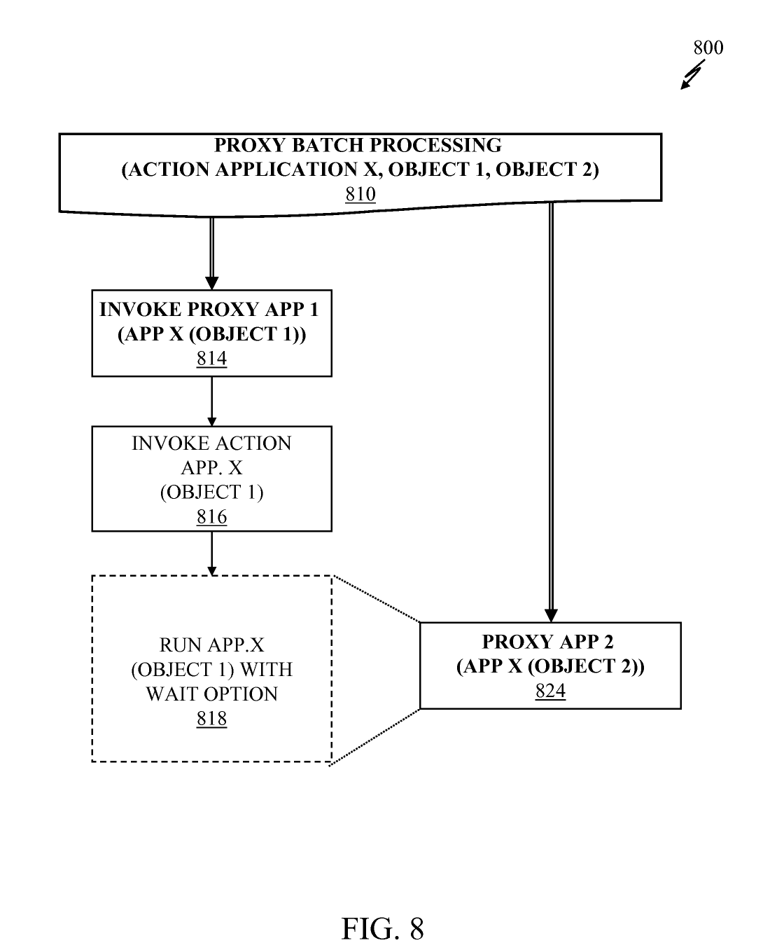

FIG. 8 is an exemplary block diagram 800 showing another exemplary timing of when a subsequent proxy application may be invoked. In this example, let us assume that two objects are selected as a batch for PB processing—object 1 and object 2, to be processed by action application X 810. After selecting the multiple objects via a PB action option, the first instance of the proxy application 814 is invoked. The proxy application typically is aware of which object it is associated with and which action application to invoke. Proxy application 1 814 in turn invokes the action application, typically passing object 1 information 816. Once invoked, action application X runs typically with a wait time 818, as discussed above. If there are five selected objects in the batch, not shown, the action application typically waits for five times, restarting the wait period after each object is received, or waits one singular wait time. The timing of when the wait time occurs during the running or processing of the action application may depend on implementation. In some embodiments, for example, the action application 660 in the PB mode defers the processing of the current object, until the expiration of the linger or wait time 818. For example, object 1 is processed after wait time 1 associated with object 1 expires. In this exemplary embodiment, the wait time is prior to application X actually processing object 1. In other embodiments, application X partially processes the passed object, and during such partial processing accepts additional objects to be processed. These additional objects are from proxy applications invoked while action application X is running. In this exemplary embodiment, proxy application 2 824 may be invoked typically at any time when application X is running so that proxy application 2 does not invoke another instance of application X. In general, a subsequent proxy application, i.e., not the first proxy application, may be invoked at any time when the application instance 660 is still running, whether the action application is waiting, i.e., within the waiting time period, or when the action application is processing the object. Similarly, if there is another object selected in the batch, not shown in the figure, proxy application 3 may be invoked when the action application is still running, whether the action application is processing objects or is within a wait time.

FIG. 9A illustrates an alternative embodiment of a proxy batch processing 900A but with the wait process relegated to an intermediate application 990. Similar to FIG. 6, this exemplary proxy batch process 900A enables a user to select multiple objects as one proxy batch via a context menu 930. In this example, the proxy batch option “Print” 950 is selected. In this exemplary embodiment, the application instance 992 does not linger or wait. The intermediate application 990 in general supports the application instance 992, if the application instance 992 is not typically adapted to support any of the PB functions, e.g., take multiple input objects or files as input, batch the multiple objects into a composite job for PB processing, or wait the appropriate linger/wait times. The alternative proxy batch processing embodiment 900A, using an intermediate application 990, may be employed, for example, to adapt to pre-existing end applications. Once the PB action 950 is selected by the context menu selection, for example, the proxy batch processing module 106 invokes a proxy application 952, 954, 956 for each object 912, 914, 916 selected. Each proxy application, similar to FIG. 6, is associated with a corresponding object. Each of the proxy applications 952, 954, 956 then sends the objects/object information 912, 914, 916, to the intermediate application 990, e.g., via an argument list. The intermediate application 990 then delays starting/initiating the action application instance 992 until the linger time expires. The linger time is typically not so long as to mistakenly include a new invocation of a new batch by the user, similar to the discussion in FIG. 6. After the expiration of the linger/wait time, the intermediate application 990 may then send the set of objects received via the proxy applications, as a single instance batch call to the action application. This batch call may also be implemented as a shell command passing all the objects as a set, e.g., in one argument list. The application instance 992 is adapted to take multiple files as input as well as combine or batch these input objects into a composite job/batch output, but is not adapted to wait or linger.

In this exemplary embodiment, only one instance of the application 992 is also invoked and the set of objects in the proxy batch are processed as one unit by the application instance 992 thereby resulting in one batch output 970. If post-processing is to be performed, for example, at a printer, the one batch output thus may be processed as one unit, similar to the output discussed in FIG. 6.

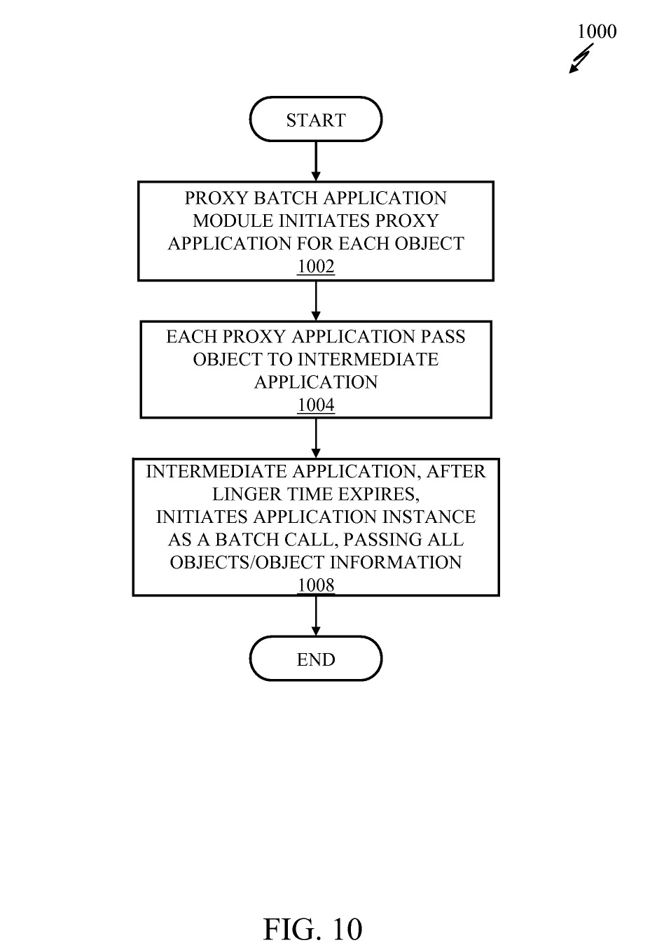

FIG. 10 is a flowchart of an exemplary PB process 1000, according to an embodiment of the invention. In this embodiment, the proxy batch processing module 106, for example, initiates or invokes the appropriate number of proxy applications based on the number of objects selected (step 1002). Each proxy application also passes its associated object/object information to the intermediate application (step 1004).

In some embodiments, not shown, the intermediate application 990 is invoked by the first proxy application 952. Each proxy application, for example, may check if the intermediate application 990 is already running, e.g., in a similar manner that a proxy application may check if an instance of an action application is running (see FIG. 7, for example). In this case, instead of checking if the instance application is running, the proxy application checks if the intermediate application is running. If the intermediate application is not running, the proxy application invokes the intermediate application passing also the associated object/object information. Otherwise, the proxy application does not invoke another instance of the intermediate application 990 but just passes the associated object/object information to the intermediate application.

In some embodiments, the intermediate application 990 is invoked by the proxy batch processing module 106. This may be implemented, such that, when a proxy batch action selection is selected, in addition to invoking the various instances of proxy applications, the intermediate application is initiated, for example, prior to the first proxy application. The first shell command, for example, invokes the intermediate application 990 and the second shell command invokes the first proxy application 952.

Once the linger time expires, as defined within the system, for example, the intermediate application 990 accordingly invokes the appropriate application 992 adapted to support the one or more selected objects (step 1008). This invocation of the action application 992 is typically a batch call.

Referring to FIG. 9B, in some embodiments, an application instance 992 may not be adapted to accept multiple input objects or not be adapted to combine the results of multiple input objects into a proxy batch job by combining all the objects into one output. FIG. 9B is similar to FIG. 9A with some variations, according to embodiments of the present invention. Similar to FIG. 9A, this exemplary proxy batch process 900B enables a user to select multiple objects as one proxy batch via a context menu 930. In this example, the proxy batch option “Print” 950 is selected. Once the PB action 950 is selected by the context menu selection, for example, the proxy batch processing module 106 invokes a proxy application 952, 954, 956 for each object 912, 914, 916 selected. Each proxy application, similar to FIGS. 6 and 9A, is associated with a corresponding object. Each of the proxy application 952, 954, 956 then sends the objects/object information 912, 914, 916, to the intermediate application 990, e.g., via an argument list. The intermediate application 990 then delays starting/initiating the action application instance 992 until the linger time expires. The linger time is typically not so long as to mistakenly include a new invocation of a new batch by the user, similar to the discussion above. In this exemplary embodiment, the application instance supporting the objects 912, 914, 916 is not adapted to accept multiple input objects or not be adapted to combine the results of multiple input objects into a proxy batch job to produce one batch output. In this exemplary embodiment, the intermediate application calls one instance of each application instance for each object selected, e.g., application instance #1 932 is passed object 1 912, application instance #2 934 is passed object 2 914, and application instance #3 936 is passed object 3 916. The several application instances 932, 934, 936 may all be invoked all at the same time, sequentially from each other, or in any other manner known to those skilled in the art. The output of each application instance 942, 944, 946 is then received by the intermediate application 990, to coalesce or combine the multiple objects into one batch output 970, containing object 1, object 2, and object 3. The application instance calls may be implemented as shell commands.

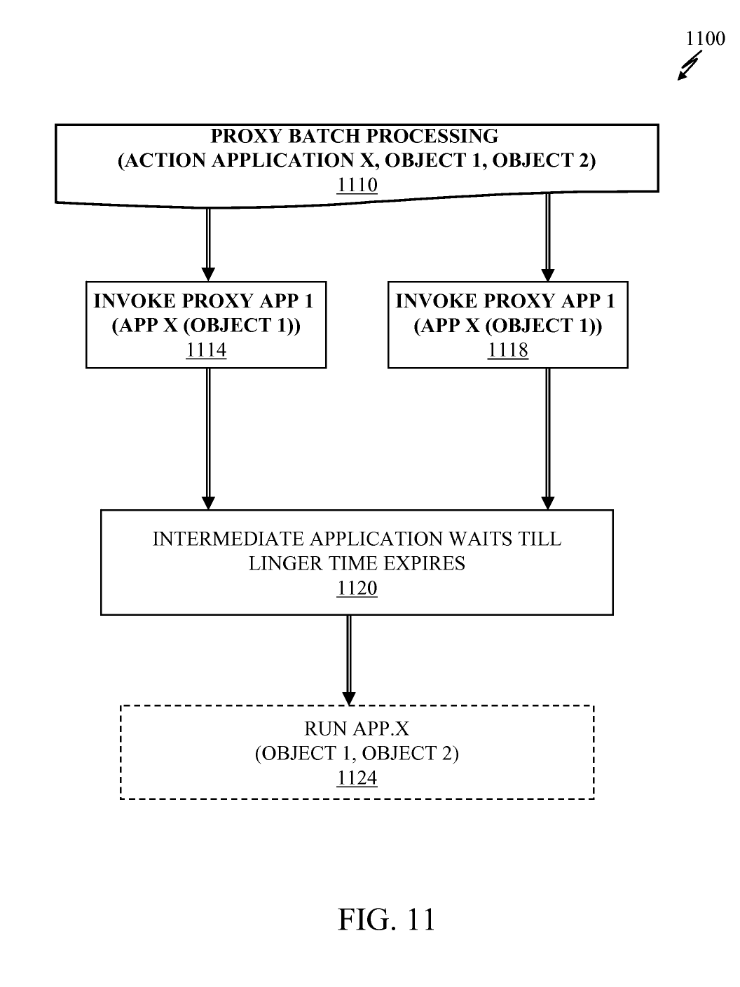

FIG. 11 is another exemplary block diagram 1100 showing another exemplary timing of a PB process 1100. In general, the proxy batch processing module 1110, 106 invokes each of the proxy applications 1114, 1118, typically in sequential order. One of the proxy applications 1114, 1118 invokes the intermediate application 1120, e.g., by the first proxy application 1114 in the batch. In some embodiments, the PB processing module 1110, rather than a proxy application, invokes the intermediate application 1120. The intermediate application waits till the linger time expires 1120, and then accordingly invokes the action application(s) passing the exemplary selected objects 1124, e.g., object 1, object 2. There may be only one call to the application instance, e.g., App X 1124 (see FIG. 9A) or multiple application instance calls (see FIG. 9B), typically depending on the PB functions supported by the application. The intermediate application 990 of the present invention is thus aware of the PB features supported by the application instance, so as to determine whether to invoke only one or multiple application instances.

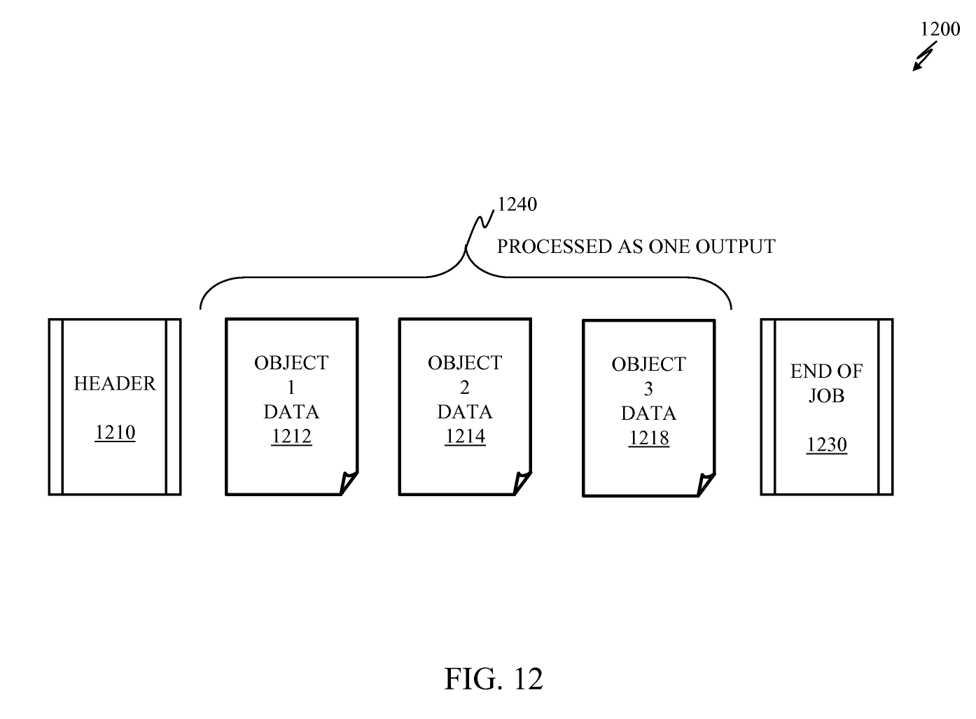

FIG. 12 is a high-level exemplary block diagram representation of a batch output 1200 according to an embodiment of the invention. In general, a print output may include header information 1210, which may include information relevant to the document. Header information may include job control commands, the document file type, formatting information, job accounting and access control, non-processed information (commentary), etc. For this example, each selected object data, e.g., object 1 1212, object 2 1214, and object 3 1218, is typically concatenated with each other, as shown. The end of job indicator 1230 indicates an end of the job or output. When printing the selected objects via the context menu option of the present invention, the selected objects are treated as one job 1240, as shown. The PB processing of the present invention thus enables selected objects to be treated as one. If the objects are defined to be stapled together, the printer of the present invention staples the one batch as one document. If this exemplary output 1200 is going to be faxed, the output is transmitted in one facsimile transmission.

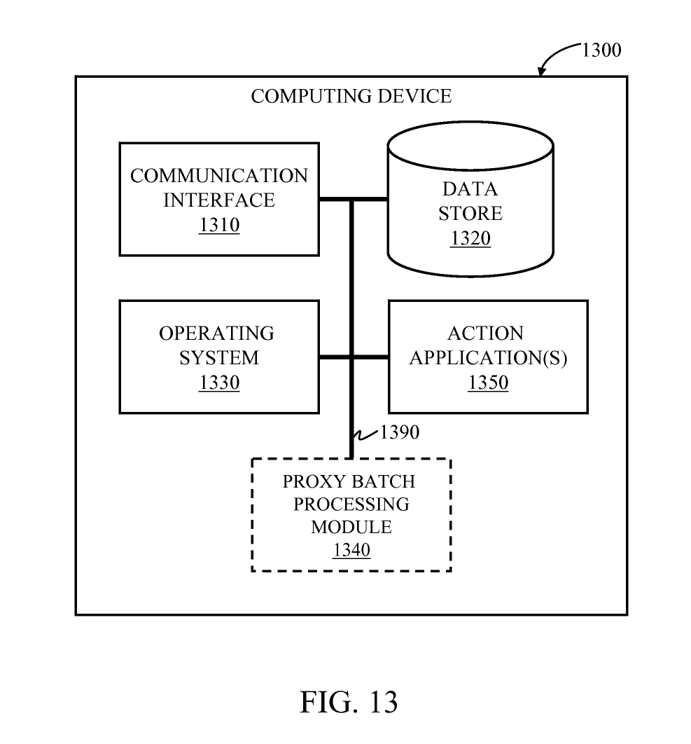

FIG. 13 is a high-level block diagram of an exemplary computing device 1300, which may include a communication interface 1310, an OS 1330, a proxy batch processing module 1340, a data store 1320, and one or more action applications 1350 adapted to support action options for PB processing. In some embodiments, the communication interface 1310 is a module adapted to enable the computing device to communicate via the network, e.g., embodied as network interface card. In some embodiments, the computing device is not operably coupled to the network. The data store 1320 typically stores objects, which may also include the OS 1330, the action applications 1350, and/or the proxy batch processing module 1340. The OS 1330 is typically a set of program instructions adapted to control and manage the operations of the computing device, including processes invoked. An action application 1350 is typically a set of program instructions adapted to perform selected action options selected by a user, for example, via the context menus. Examples of action applications may include word-processing programs, drawing programs, faxing programs, printing programs, viewing programs, etc. Examples of action applications 1350 may include, but are not limited to, MS OFFICE products, ADOBE™ line of products, e.g., ADOBE™ READER™, and typically any application supported within the OS. The proxy batch processing module 1340 is shown in dashed lines. Depending on the implementation of the PB processing module, the various pieces or features of such a module may be incorporated in various places, for example, as shell commands, as a packaged application, changes to the OS, changes to the action application(s), addition of context menu handlers, registry modifications, file locking, and file creation. In other embodiments, some of or all of the PB batch processing features or functions of the present invention may be incorporated in the action application or into an intermediate application. In some embodiments of the invention, the different modules of the computing device 1300 may communicate and interface with each other via a bus, dedicated signal paths or one or more channels 1390.

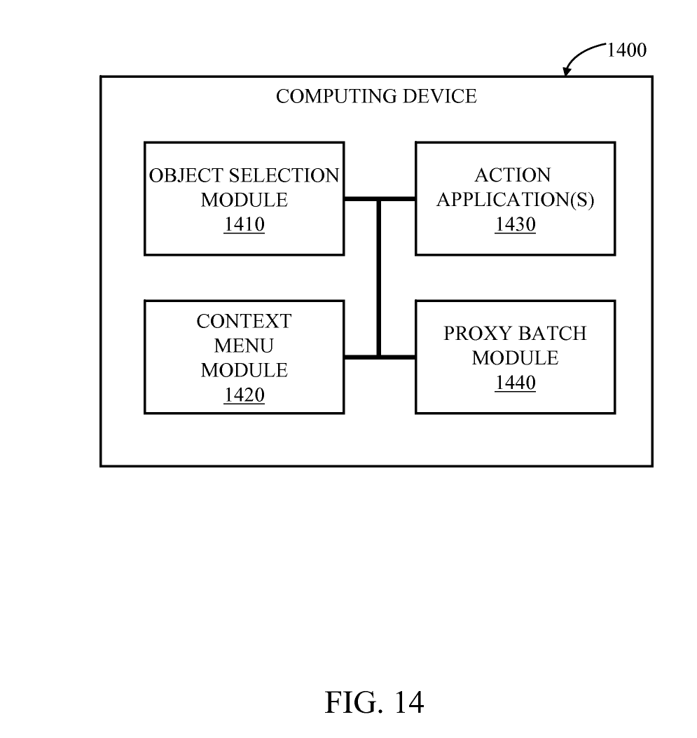

FIG. 14 is a high-level block diagram of another exemplary computing device 1400, according to an embodiment of the invention. The exemplary computing device may include an object selection module 1410, a context menu module 1420, one or more action applications 1430, and/or a proxy batch module 1440. The object selection module 1410 is typically adapted to enable a user to select one or more objects for PB processing. The context menu module 1420 is typically adapted to present a context menu in response to an input, e.g., right click. The context menu presented may depend on the object selected by the user. The context menu module 1420 is also adapted to receive an action selection and associate this action selection to an appropriate action application 1430. The action application 1430 is typically adapted to perform a wait function, as described above, process said selected one or more objects, and to terminate based on a condition. The processing of the selected objects is typically based on the action selected from the context menu. The proxy batch module 1440 is typically adapted to invoke one or more instances of a proxy application. Each invoked proxy application is typically associated with an object from the selected objects. The invoked proxy application is also typically adapted to invoke an instance of an action application and/or pass the associated object of an invoked proxy application to the application. In some embodiments, an intermediate application is adapted to invoke a single or multiple application instance calls.

Depending on the function of the exemplary computing device 1300, 1400, other modules, including functions and capabilities, may be added or removed. Furthermore, the modules described herein may be further subdivided and combined with other functions so long as the functions and processes described herein may be performed. The various modules described in this computing device may also be embodied in a set of program instructions, e.g., software, hardware, or both hardware and software, i.e., firmware.

Embodiments of the present invention may be used in conjunction with networks, systems, and devices that may employ batch processing particularly via context menus. Although this invention has been disclosed in the context of certain embodiments and examples, it will be understood by those of ordinary skill in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of ordinary skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

I claim:

1. A method of proxy batch processing, the method comprising the steps of:
receiving a batch of one or more objects, wherein said batch is associated with an action application adapted to support said batch of one or more objects;
invoking a separate instance of a proxy application for each object within said batch, wherein said each separate instance of the proxy application is associated with an object in said batch;
determining by said each separate instance of said proxy application whether said action application is running;
if said action application is not running, invoking an instance of said action application and passing the associated object of said instance of said proxy application to said action application; and
if said action application is running, passing the associated object of said instance of said proxy application to said action application;
wherein said action application is adapted to have a wait time and is adapted to terminate when said wait time expires without receiving any passed objects to said action application.

2. The method of claim 1, further comprising the step of:
receiving, via a context menu, an action selection associated with said batch, wherein said action selection is associated with said action application.

3. The method of claim 1, wherein said action application is adapted to wait before or after processing an object from said objects passed to said action application.

4. The method of claim 1, wherein some of said each separate instance of said proxy application is invoked when said action application is processing an object from said objects passed to said action application.

5. The method of claim 1, wherein at least two of said invoked separate instances of the proxy application are invoked at a time interval such that one of said at least two invoked separate instances is invoked after the other of said at least two invoked separate instances at the time interval less than said wait time of said action application.

6. The method of claim 1, wherein said step of invoking said separate instances of the proxy application is via one or more shell commands.

7. The method of claim 1, wherein said passing the associated object of said instance of said proxy application to said action application is indicated by an object in a defined location.

8. The method of claim 1, further comprising the step of generating a batch output by said action application.

9. The method of claim 10, wherein said batch output is processed by a printer.

10. A computing device adapted to perform proxy batch processing, the device comprising:
a selection module adapted to enable selection of one or more objects;
a context menu module adapted to:
present a context menu in response to an input, wherein said context menu is based on said selected one or more objects; and
receive an action selection and associate said action selection to an action application;
said action application adapted to:
perform a wait function associated with a wait time;
process said selected one or more objects based on said action selection; and
terminate when said wait function expires without receiving any passed objects; and
a proxy batch module adapted to invoke one or more instances of a proxy application, wherein each proxy application invoked is associated with an object from said selected one or more objects; and
wherein each of said invoked proxy application is adapted to:
if said action application is not running, invoke an instance of said action application and to pass the associated object of said instance of said proxy application to said action application; and
if said action application is running, pass the associated object of said instance of said proxy application to said action application.

11. The device of claim 10, wherein the proxy batch module is further adapted to invoke at least some instances of the proxy application at an interval less than said wait time of said action application.

12. The device of claim 10, wherein said proxy batch module is further adapted to invoke one or more instances of a proxy application via one or more shell commands.

13. The device of claim 10, wherein said action application is further adapted to process said selected one or more objects based on said action selection by generating a batch output.

14. The device of claim 13, wherein said batch output is faxed via one transmission by a peripheral device.

15. The device of claim 13, wherein said batch output is printed by a peripheral device.

16. A method of proxy batch processing, the method comprising the steps of:
receiving a batch of one or more objects, wherein said batch is associated with an action application adapted to support said batch of one or more objects;
invoking a separate instance of a proxy application for each object within said batch, wherein said each separate instance of the proxy application is associated with an object in said batch;
invoking an intermediate application;
invoking by the intermediate application, after expiration of a wait time, the action application adapted to support said batch of one or more objects; and
passing the batch of one or more objects as a set to said invoked action application.

17. The method of claim 16, wherein the step of invoking the intermediate application is performed by a first proxy application from the invoked separate instances of proxy applications.

18. The method of claim 16, further comprising the step of:
receiving, via a context menu, an action selection associated with said batch, wherein said action selection is associated with said action application.

19. A computing device adapted to perform proxy batch processing, the device comprising:
a selection module adapted to enable selection of one or more objects;
a context menu module adapted to:
present a context menu in response to an input, wherein said context menu is based on said selected one or more objects; and
receive an action selection and associate said action selection to an action application;
said action application adapted to:
process said selected one or more objects based on said action selection;
a proxy batch module adapted to invoke one or more instances of a proxy application, wherein each proxy application invoked is associated with an object from said selected one or more objects; and
wherein each of said invoked proxy application is adapted to pass the associated object of said instance of said proxy application to an intermediate application; and
said intermediate application adapted to:
invoke said action application, after a wait time expires; and
pass to said action application said one or more objects received from the proxy application.

20. A method of proxy batch processing, the method comprising the steps of:
receiving a batch of one or more objects, wherein said batch is associated with an action application adapted to support said batch of one or more objects;
invoking a separate instance of a proxy application for each object within said batch, wherein said each separate instance of the proxy application is associated with an object in said batch;
invoking an intermediate application adapted to perform a wait time function;
invoking by the intermediate application, after expiration of a wait time, a separate instance of said action application for each object within said batch;
passing the output of said each separate instance of said action application to said intermediate application; and
combining each of the output of said each separate instance of said action application into one batch output, comprising data of each object of said batch.

21. The method of claim 20, wherein the step of invoking the intermediate application is performed by a first proxy application from the invoked separate instances of proxy applications.

22. The method of claim 20, further comprising the step of:
receiving, via a context menu, an action selection associated with said batch, wherein said action selection is associated with said action application.

23. A computing device adapted to perform proxy batch processing, the device comprising:
a selection module adapted to enable selection of one or more objects;
a context menu module adapted to:
present a context menu in response to an input, wherein said context menu is based on said selected one or more objects; and
receive an action selection and associate said action selection to an application;
said action application adapted to:
process said selected one or more objects based on said action selection to produce an output; and
transmit the output to the intermediate application;
a proxy batch module adapted to invoke one or more instances of a proxy application, wherein each proxy application invoked is associated with an object from said selected one or more objects; and
wherein each of said invoked proxy application is adapted to pass the associated object of said instance of said proxy application to an intermediate application; and
said intermediate application adapted to:
invoke one or more instances of said action application for each object within said batch, after a wait time expires, wherein each separate instance of the action application is associated with an object in said batch;
receive the output of said each separate instance of said action application; and
combine the received output of said each separate instance of said action application into one batch output, comprising data of each object of said batch.
